(19) United States
(12) Patent Application Publication
(10) Pub. No.: US 2014/0280264 A1
(43) Pub. Date: Sep. 18, 2014

(54) APPARATUS, DATA STRUCTURE, AND METHOD FOR MEDIA FILE ORGANIZATION

(71) Applicants: Thomas C. Fix, West Lakeland Township, MN (US); Randal D. Olson, Lakeland, MN (US)

(72) Inventors: Thomas C. Fix, West Lakeland Township, MN (US); Randal D. Olson, Lakeland, MN (US)

(21) Appl. No.: 14/214,036

(22) Filed: Mar. 14, 2014

Related U.S. Application Data
(60) Provisional application No. 61/785,381, filed on Mar. 14, 2013.

(51) Int. Cl. G06F 17/30

(52) U.S. Cl. CPC G06F 17/30569
USPC 707/756

(57) ABSTRACT

This invention augments media files, using an apparatus that reads instructions within media files to control methods for processing meta data and media data and inputting data from a human user, and outputting transformed data. Some embodiments include a data structure having a plurality of media instructions stored within an ISO media file, that, when executed, functionally transform video information on the media file, based on input information elicited and received from a human user and on the data structure, to an output signal that includes video modified by the input information and the data in the structure. In some embodiments, a method reads media file, eliciting and receiving input information from a human user; and functionally transforming the media file audio-video data based on the input information received from the user and control data in the data structure(s) into modified outputs as controlled by the instructions.

### CROSS-REFERENCE TO RELATED APPLICATIONS

This application claims priority benefit, under 35 U.S.C. §119(e), of U.S. Provisional Patent Application No. 61/785,381, filed Mar. 14, 2013, which is incorporated herein by reference in its entirety.

### FIELD OF THE INVENTION

This invention relates to the field of media file organization, and more specifically to a method and apparatus of augmenting media files with instructions or scripts, and associated methods of making and using such augmenting media files, as well as data structures used for instructions and control information for augmenting media files.

### COPYRIGHT & TRADEMARK NOTICES

A portion of the disclosure of this patent document contains material, which is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of the claimed subject matter to material associated with such marks.

### BACKGROUND OF THE INVENTION

U.S. Pat. No. 7,711,718 issued to Hannuksela on May 4, 2010 with the title “System and method for using multiple meta boxes in the ISO base media file format”, and is incorporated herein by reference. Hannuksela describes a metabox container box which is capable of storing multiple meta boxes for use. The meta-box container box can also include a box which indicates the relationship between each of the meta boxes stored in the meta-box container box. Various embodiments described are also said to be backward-compatible with earlier versions of the ISO base media file format.

U.S. Pat. No. 8,365,081 issued to Amacker, et al. on Jan. 29, 2013 with the title “Embedding metadata within content”, and is incorporated herein by reference. Amacker et al. describe techniques for embedding metadata into a piece of content. With use of the embedded metadata, an application takes one or more actions specified by the embedded metadata upon selection of the content. In some instances, the content comprises an image, video, or any other form of content that a user may consume. Using the example of an image, the techniques may embed metadata within the image to create an image file that includes both the image and the embedded metadata. Then, when an application of a computing device selects (e.g., receives, opens, etc.) the image file, the application or another application may perform one or more actions specified by the metadata.

There remains a need in the art for improved ways to augment media files with instructions or scripts.

### SUMMARY OF THE INVENTION

This invention augments the prior art of media files, to create an apparatus of instructions or scripts within media files, to allow methods to control and process media file meta data and media data, to allow methods to input data external to the media file for this control and processing, and to allow methods to output data external to the media file. The media-file content used in most popular media files is defined by international standards. The International Organization for Standardization (ISO) and the International Electrotechnical Commission (IEC) created Standard 14496 part 12, “ISO base media-file format,” to define a standard media-file organization for containing time-sampled media, in a format conducive to interchange, manage, edit and present the media. The file format categorizes the data, into a hierarchical structure of atomic “boxes.” In some embodiments, the four most important top-level boxes are 1) the file-type “ftyp” box that identifies the specifications for which the specific file complies, 2) the media-data “mdat” box that contains time-ordered sampled video and audio (media) frames, 3) the movie “moov” box that contains metadata (e.g. track position data), and 4) “free” boxes that may contain any content not defined by the Standard. The popular 3GP (3GPP), MP4 (MPEG), FLV/F4V(Adobe), and QuickTime (Apple) file formats are based on the part-12 Media Container Standard. Part 12 is a derivative of Apple's QuickTime specification. MP4 is part 14 of the ISO 14496 Standard. The prior art in this field limits media-file instructions to the formatting of packets for streaming protocols and to the formatting of packets for transmission. Prior art also includes U.S. Pat. Nos. 8,365,081 and 7,711,718, which are incorporated herein by reference, and which describe methods that operate on existing media-file apparatus.

The present invention defines and describes an apparatus, a computer-implemented method, and a computer-readable medium that augment the present media file's art to include dynamic control and annotation of media playback.

### BRIEF DESCRIPTION OF THE DRAWINGS

FIG. 1 is a table 100 showing ISO/IEC Standard 14496 part 12 “Free Box” that allows definition of instructions.

FIG. 2 is a listing 200 of object and source code for cooking instructions shown in a cooking-training video.

FIG. 3 is a block diagram 300 of an architecture for media instructions shown executed interpretatively by compiled code on a smart phone.

FIG. 4 is a screen shot diagram 400 of one method of capturing a user's video script, by using an Android Application that implements frame-by-frame video controls.

FIG. 5 is a listing 500 of one simple embodiment that provides enablement of scripting, using open-source software.

FIG. 6 is a listing 600 of instructions included in one embodiment of a biometric financial-transaction ISO media file.

FIG. 7 is a block diagram 700 of an architecture for instructions shown executed interpretatively or by compiled code, in a processor's secure partition space.

FIG. 8 is a block diagram 800 of an architecture for categorization used by some embodiments of the invention.

FIG. 9A is a schematic cross-section diagram 900 showing a single pixel element in a Foveon×12 CMOS image sensor and the color-space pixel formed from 12 visible frequency bands.

FIG. 9B is a graph 950 of the color-space pixel response (arbitrary units on the Y axis) versus frequency (wherein frequency bands b1 through r4 on the X axis map to light wavelengths of 400-700 nm).

FIG. 10 is a graph 1000 showing the reflectance spectral function for a green leaf and a green polycarbonate.

FIG. 11 is a listing 1100 of instructions included in one embodiment of an ISO media file containing 12 visible frequency bands.

FIG. 12 is a screen shot diagram 1200 showing a superposition of the frame used in FIG. 4, with the generated text box obtained using one method of capturing and annotating materials' properties on an Android mobile phone.

FIG. 13 is a diagram 1400 of one method of recording scripts and writing them to an ISO Media File.

### DESCRIPTION OF PREFERRED EMBODIMENTS

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

### DEFINITIONS OF TERMS

Media File: As used herein, this term is defined as data structures that are stored on a computer-readable medium that contain multi-media content, along with metadata that identifies the content and/or assists and controls player software used to output human discernible renderings of the content (e.g. to audio-output and video displays). In some embodiments, this includes ISO base-media file data structures, and the ISO variants such as Apple QuickTime container-file data structures and Adobe Flash Video container-file data structures. In some embodiments, this includes DVD-video, DVD-VR, DVD+VR, DVD-VOB, Blu-ray container-file data formats, and MPEG transport stream data structures.

Player Software: As used herein, this term is defined as the set of instructions executed to perform computer implemented methods to read multi-media content in media file, using codecs or language mappings to the content, to process, display, or play the content on audio and/or video displays.

Information Processor: As used herein, this term is defined as any computer such as those controlling operation of DVD players, BluRay® players, video players that read data from media files, speakers, internet TV players (AppleTV®, Roku®, and others), information processors including those that may be built into refrigerators, sewing machines, microwave ovens, stoves, video game machines (Xbox®, Xbox 360®, Xbox One® Wii®, PS3®, PS4®, and others).

Operator Basis: As used herein, this term is defined as a mathematical organization of a set of operators, to enable complete mathematical representations of the image, video, or audio fields' phenomena.

Media instructions: As used herein, this term is defined to include instructions, operators, pseudo operators, a plurality of computer programming-language syntax elements, and scripts placed within instruction-suitable fields of the Media File, the ISO Free or Skip boxes of ISO Media Files, or other spare boxes, to implement the Claims.

Input device: As used herein, this term is defined as a device that elicits and receives information from a human user and inputs the received information into a computer. In some embodiments, the input device is a keyboard (or keypad or touch screen or the like) and its controller hardware. In some embodiments, the input device wirelessly communicates the information. In some embodiments, the input device is implemented as two or more separate units such as a display screen, speaker output unit and/or the like for eliciting a response from a human user, and a keyboard, mouse, microphone, camera and/or the like for receiving the response from the human user.

Input information: As used herein, this term is defined as input information obtained from media-file data structures and the like, and/or from input devices that elicit and receive information from a human user.

Human-input information: As used herein, this term is defined as inputs obtained from input devices that elicit and receive information from a human user.

Computer-input information: As used herein, this term is defined as inputs obtained from media-file data structures and the like.

Output device: As used herein, this term is defined as a device that receives processed output information.

Media-instruction-modified output signal: As used herein, this term is defined as any media-instruction-modified output information that results from execution of the media instructions of the present invention to modify data read from a media file. This term media-instruction-modified output signal includes data sent to any destination, whether to a video display device, to a media file, or across a telecommunication network to a server.

Media-instruction-modified video-output signal: As used herein, this term is defined as media-instruction-modified output information sent to be promptly displayed on a video display device.

Media-file-output signal: As used herein, this term is defined as media-instruction-modified output information sent to be stored into a media file (whether it's stored back into the original media file from which the present invention read data and media instructions used to generate the media-file-output signal, or stored into a different media file).

External-device-output signal: As used herein, this term is defined as media-instruction-modified output information sent to a remote device. For example, in some embodiments, the remote device can be accessed across a telecommunication network to a server.

Human-presentation-output device: As used herein, this term is defined as a device that renders processed output information into a form perceptible to a human. In some embodiments, the human-presentation-output device includes an electronic visual display (e.g., an LCD screen, plasma screen, CRT screen and/or the like) and its/their associated controller hardware. In some embodiments, the human-presentation-output device includes an audio output device and/or devices to stimulate other senses such as a vibration device that can output vibrations to be felt by a human, or a scent-output device that outputs something that can be sensed by smell, or other type of output device that outputs something for the human senses.

Media-box information: As used herein, this term is defined as outputs written to or read from media-file data structures.

Human-presentation-output-device information: As used herein, this term is defined as outputs written to a human-presentation-output device.

Functional transform: a transform of a set of input data into a set of output data. In some embodiments, this transform is a mathematical operation applied to a set of input data, to produce a set of output data in a plurality of mathematical spaces. In some embodiments, this transform is an algorithmic conversion of a set of inputs to a set of outputs. In some embodiments, this transform is a conditional transform that maps a set of inputs to different sets of outputs, depending on the value(s) of a plurality of the inputs.

Homomorphic transform means a common conventional mathematical transform that reduces image-information content in video, image or audio frames to a representation of pertinent information. In some embodiments, the color image-information is reduced to black-and-white grayscale image information. In some embodiments, the mathematical structure, such as separability, is preserved across the transform.

Unitary transform means the standard definition of a conventional unitary mathematical transform. In some embodiments, the unitary transforms include such common operations as expanding an image into an orthogonal basis-image representation, transforming an image into a separable representation, reducing the correlation between transform coefficients, and rotating an image. In some embodiments, the unitary transform preserves entropy (information content), within practical limits, in contrast to a homomorphic transform which usually reduces information.

The present specification shows the enablement and demonstration of the invention, through three different embodiments. The present invention, of course, is not limited to these three example embodiments. In some embodiments, the present invention extends the definition of ISO media files to include processing instructions or scripts that are placed in one or more additional or spare field(s) of the ISO media file. In some other embodiments, the present invention modifies other types of media files (such as those used for DVDs) to include processing instructions or scripts that are placed in one or more additional or spare field(s) of the respective media file. The instructions' or scripts' operator basis processes the video and audio data read from the media file, and it elicits and receives input data from human users and outputs augmented data to a location or device (such as a video monitor and speaker) external to the file (and the operator basis optionally outputs data into the media file). In some embodiments, the operator basis includes ad-hoc instructions or scripts, as shown in the first embodiment set forth below, or, in other embodiments, includes a formal language with an operator basis that is complete enough to include all needed operators used in various different engineering and scientific fields.

FIG. 1, FIG. 2, FIG. 3, and FIG. 4 show a first embodiment of the present invention. FIG. 1 shows a table 100 having a “free box” data structure 111 defined within the ISO/IEC Standard 14496 part 12 (hereinafter called the “ISO Standard”) that allows definition of instructions. In this embodiment, the “free boxes” allowed by the Standard are used in the present invention to define instructions or scripts, such that the instructions or scripts do not interfere with the defined behavior of the Standard, but implement the present invention's functions (reference number 101). A plurality of these boxes is permitted by the standard and is used in some embodiments of the present invention (reference number 102).

FIG. 2 is a media-instruction listing 200 of object and source code for cooking instructions shown in a cooking-training video. FIG. 2 continues FIG. 1's demonstration of the first embodiment, using a simple-training video to illustrate the basic concepts of the present invention. FIG. 2 shows a hexadecimal “dump” of object-code instructions 210 that are inserted into an example cooking.mp4 training video file whose structure is defined by the ISO Standard. In some embodiments, the object-code instructions 210 are embedded in a “FREE” box. Column 220 shows the embedded instructions in an ASCII source-code representation. An instruction marked by 201, begins the instructions. An instruction marked by 207 ends the instructions. An instruction marked by 202 stops the video and audio playback of the cooking training video, at frame 540. Instruction 203 will draw a red arrow from pixel location 72, 333 to 278, 367. Instruction 204 will write a text box over the video at pixel location 390, 52 with the words “Add ¼ tsp salt.” Instruction 205 ends the data defined by the text-box instruction. The program elicits and received input from a user (e.g., from a cook watching the video) by displaying a button “BT01” and monitoring and receiving input from the button Listener (e.g., a Java run-time service call such as 505 of FIG. 5). Instruction 206 restarts the video when the program determines from the input that the cook watching the video has pressed the button referenced with the symbolic name of BT01. The video tracks data containing the cooking-training video tracks reside within the mdat ISO box. This data is stored within the mdat box indicated by reference number 208.

FIG. 3 is a block diagram 300 of an architecture for media instructions shown executed interpretatively by compiled code on a smart phone. FIG. 3 continues FIG. 1's and FIG. 2's demonstration of the first embodiment. FIG. 3 shows the relation of the cooking.mp4 video file instructions to their interpretive execution by compiled software that, in some embodiments, resides on a smart phone 310. In some embodiments, the video file 301 resides within SD memory 311 on smart phone 310. In some embodiments, the code that interpretatively executes the metadata of the present invention resides within a software application 302 that resides on the same smart phone 310. In some embodiments, the code 302 opens the video file 301, then executes the present invention's FREE instructions 304 (the instructions embedded in one or more free boxes(s) of the .mp4 file) to control the video playback. This includes waiting on a button input 305 (for the button's possible activation by a human user, which is then an input received from the human user), and playing back video and annotated text/graphics to the smart phone display 306.

FIG. 4 is an exemplary screen shot diagram 400 of one method of capturing a user's video script, by using an Android application that implements frame-by-frame video controls. FIG. 4 continues the demonstration of FIG. 1, FIG. 2 and FIG. 3 of a training-video embodiment, by showing one method of capturing a user's training video script, inserting it into a video file, and then using the script to play it back. FIG. 4 shows an Android application that records scripts, by using frame-by-frame video controls. For each displayed button shown in the Application's displayed touchscreen 400, the application creates a Java OnTouchListener that is invoked when that button is pressed. The Android Java OnTouchListener will be invoked both when the play button, 401, is first pressed and when the press stops. When the press stops, the Application displays frame 540 in the text box at reference 402. It records the action in the script as a “stop at frame” media instruction, marked by 202, with frame 540 as the operand, referenced by 209. If the “arrow” button referenced by 403 is pressed, and the “red” button marked by 404 is pressed, and the user then drags his or her finger across the screen, then OnTouchListeners will add a “draw red arrow” operation, 203, with these coordinates, to the script. Each of the different presses, the red button, the arrow, and the background finger drag, invoke different Listeners (e.g., different Java run-time service calls), that construct a single complete media instruction (e.g. a single script operation). In some embodiments, the Android application will invoke a keyboard when the bottom of the screen, 406, is touched (i.e., causes the software application 302 to display a keyboard and to receive input from the touch screen locations over the displayed keyboard). (This isn't shown in FIG. 4, because the keyboard overlays the previous indications.) When the text message is typed, the application records into the script a “add text box” media instruction, with the coordinates and text.

FIG. 5 is a media-instruction listing 500 of one simple embodiment that provides enablement of scripting, using open-source software. FIG. 5 continues the demonstration (set forth above and shown in FIG. 1, FIG. 2, FIG. 3, and FIG. 4) of a training-video embodiment, by showing how easily the developer can enable the capture of a user's script and enable its write to the ISO media file, using open-source software tools or GNU-licensed tools. In the training-video embodiment, the Android application opens the file, with an open-source “FFMPEG” tool that contains a codec 501. A codec codes and decodes video, image, or audio data. In this case, the tool reads and decodes the frames of video data, as marked by reference numbers 502 and 503. The Android SDK Java RTS method “setImageBitmap” displays the video frame, referenced by 504. When the user drags their finger across the screen to create the green arrow, the Android Java listener, marked by reference number 505, picks up the start and end arrow pixel locations. All of these scripted parameters and others are then written to the ISO media file, using the Java RTS method “write” as marked by 506.

FIG. 13 reference 1425 shows one embodiment, a Java application 1431 on a smart phone 1430 appending the free box 1425 containing the script to the original ISO media file, reference 1401. Appending the script's free box(s) to the end of the media file, instead of inserting it between other boxes, avoids the cumbersome chore of recalculating mdat track offsets in the moov box. These offsets are relative to the start of the file, rather than the start of the mdat box, so these offsets change if a box is inserted before the media track-data.

In some embodiments, the invention's methods quickly and easily create a training video, from any ISO media file, using the constrained editing features of a mobile phone. The set of needed operators to support the scripting of the training video is limited. In the above example, operators were only needed to annotate the graphics and control the frame playback.

In the second embodiment, the scripts' set of instructions and operators are formalized within a programming language, with a sufficient set of image and audio operators, to permit dynamic control of device input signals, device output signals, and data internal to the media file. In this second embodiment, other types of software problems are solved by the invention's use of embedded scripts or instructions in ISO media files.

FIG. 6 is a media-instruction listing 600 of media instructions included in one embodiment of a biometric financial-transaction ISO media file.

FIG. 7 is a block diagram 700 of an architecture for instructions shown executed interpretatively or by compiled code, in a processor's secure partition space.

FIG. 6 and FIG. 7 continue FIG. 1's demonstration, with another particular embodiment that shows the “patent enablement” of the advanced features or claims of the invention. This embodiment uses the .mp4 invention's scripts to create, and encrypt a financial transaction, on a processor partitioned for security. An example of a partitioned hardware design used by some embodiments of the present invention is a newer version of the ARM-type processor that employs “TrustZone.” The processor design separates or partitions the processor into two processing spaces, to prevent general processing in the first space 702 from accessing secure data or instructions in the second space 706. Because of malware and other threats, many businesses that need secure processing (e.g. financial transactions) are using the ARM's TrustZone. These partitioned designs have existed for several decades in the Avionics Industry, because FAA standards required separating software developed to different levels of robustness, into separate logical or physical partitions. Those older hardware partitioned designs, such as used in avionic board-designs, used processor pin outs to select the appropriate address state, through address decoders, selection through high-speed component busses (e.g., an SPI interface), or through glue logic. With the proliferation of System on a Chip (SOC) IP Core designs, such as ARM designs, technological advancements have obviated much of this cumbersome board-level logic. Now, hardware engineers can easily replicate processors in SOCs. Generally, the secure partition (e.g. ARM TrustZone) has fewer run-time features available than the general processor-space, so this invention's simple interpreted scripts, without much Run-Time System support, are well suited to securely partitioned processors. The script extracts fingerprint biometric-data from the ISO media file's .mdat tracks 715. It obtains financial data from a display 717 and keyboard 718 controlled by the securely-partitioned driver.

FIG. 6's script is embedded in a “free” box at the bottom of the media file, marked by 601. An instruction marked by 602, begins the instruction. A pseudo-op “INDA,” marked by 628, indicates the start of a data program-section where variables are stored. The script uses “C”-like programming-language control instructions, such as the “for” and “while” conditionals, marked by 603, and 607. The script includes a clock-sampling random-number generator in its instruction set, rather than a pseudo-random number generator, to create an encryption local key, as indicated by 604. The script creates a complemented local public-key through an encryption elliptic-key algorithm, as marked by 605. The elliptic public keys are very secure, but their computational complexity is very high. A public-domain Curve25519 elliptic-curve algorithm that is simple, self contained, meets most standards, is public domain, and doesn't need much RTS support, was included in the instruction set. These keys generate an AES Symmetric Encryption key, as marked by 606, by “group” multiplying the generated public key with the generated local private key (a group multiply is defined by the group properties used in the elliptic-curve encryption mathematical model). The script uses this AES symmetric key to encrypt the compressed biometric and financial data in the data “free” box, as marked by 616 and 621. This described scheme of encrypting and decrypting data, using symmetric encryption and elliptic-curve key generation is based on the well-known and practiced Diffie-Hellman key-exchange scheme. By including encryption features into the script language, only needed parts of the ISO media file are encrypted. This is difficult, with just codecs. The script retrieves a video-track address, by directly mapping into the ISO media file, through language data structures, instead of accessing it through a codec, as done in the previous embodiment. The ISO media files data structures are very complex. Most developers desire access to this data, but cannot access it through codecs—this embodiment's mapping gives them access. The script reads the frame, referenced by the address in nextF, in the instruction marked by 609. The data is placed in an array, y, created by the byte-array storage allocation pseudo op BARRAY, as indicated by 631. The array is sized by moov.stbl.stsd.width and moov.stbl.stsd.height. These are width and heights stored in the IPO media file's sampled entry tables, containing the pixel size of the frame data. This is another example of the embodiment mapping directly to ISO media file content, within the language's data structures. In reference 610, the script uses a Gaussian-Interpolator Pyramid operator, GAUSPYR, to down sample and interpolate the frame's image. The 0.75, 3, and 2 are arguments to the operator. They specify the Gaussian sigma, the pyramid level to generate, and the down-sample rate. This is an example of a mathematical operator needed to systematically support required mathematical modeling of different application fields. This embodiment strives to provide an operator basis sufficient to support most applications. Three other mathematical operators follow, as marked by 611, 612, and 613. Wavelet transforms are a critical component of image and audio processing operator sets, because they provide filtering at different scales. At each frequency band, the subspaces form an orthogonal basis. At reference 611, the wavelet uses a WSQ wavelet basis-function, promoted by the FBI and NIST for fingerprint analysis, to convert frame x, to the wavelet space y, using a 0.9 metric that converts enough of the wavelet stage's coefficients, to achieve 90% compression. The representation is sparse, and thus is compressed. WAVECROP, reference 612, partly achieves this, by cropping the image around near zero coefficients (low-symmetry, highly entropic boundaries). At reference 613, the script applies an inverse wavelet transform to change from the wavelet subspace-representation, back to an image. At reference 615, the script checks to see if the frame is an I-frame (intra-picture frame), instead of a motion-vector image frame. If so, the frame is encrypted and reinserted back into the ISO File's Media tracks. At reference 619, the script uses an ENTROPY operator to derive the amount of symmetry in the wavelet coefficients. If this frame's entropy is lower than the previous best frame, then this frame is selected as the best frame, and saved, in the statement marked by 620. At reference 622, a unitary transform creates a KLT representation of the image, through an orthogonal decomposition into KLT image-basis functions. These image transforms are very practical and commonly used. But, unitary transforms are also used for other purposes, such as image rotations. Because of their mathematical properties, their information content is preserved through the transformation. This allows a measure of energy compaction in its coefficient, and thus provides a means of gauging the efficiency of image compression. Because of these properties and because of their separable basis, they are a key component in this embodiment's best-mode selection of a systematic set of image operators. At reference 623, a JAVA-like intent is used to invoke a GUI interface to collect the customer's name, security code, and credit-card number. It is stored in “financialdata”, reference 621, and encrypted. The temporary data structures are randomized, in step 624, to ensure secure processing. Finally, the script sends the secure .mp4 file, along with its Diffie-Hellman public keys, to a financial-processing center, in reference 625. The self-contained scripts are also transmitted, allowing the receiving software to employ the proper instructions to decrypt and decompress the .mp4. The changes to the ISO media file are saved, in reference 626. The financial institution will process the transaction and then return a receipt. The software that executes the script had saved this callback routine at reference 625. When the receipt is received, through the Ethernet driver, the callback code at reference 627 is invoked. It has a single noop instruction that does nothing. The pseudo op at reference 630 identifies the end of the FREE box. Throughout this script, all processing is performed in the secure partition of the processor, without exposure to any malware or users. The generated financial transaction is secure to NSA-specified corporate-level security requirements.

The language shown in the FIG. 6 embodiment is lexically analyzed and parsed using common open-source tools provided in the TrustZone's RTS. For this embodiment, this software is included in a TrustZone's cyclical executive. These compilers and interpreters are mature technologies that are trivially implemented with existing open-source software, so its enablement for this invention isn't necessary.

The invention's embedded scripts solve five types of problems common to applications in this embodiment: The solutions provided by the present invention include:

The media instructions transforming the data are bundled with the data, thus allowing it to correctly process transactions arising from dissimilar software and different interface definitions;

Based on the embedded media instructions, the receiver can determine how the data was transformed and the appropriate response (for example, in this embodiment, the receiver can determine from the script, the encryption algorithm used and the method to construct the biometric model; this allows it to match the data to the methods employed);

The data is transmitted through a standardized media file, allowing standardized data packaging;

By defining the ISO media file's data/box structures in the scripting language, the script can directly access the complex boxes that comprise the media files. Without the present invention's language mapping into the media files' boxes, software developers cannot easily access the media file's video, audio, and metadata, except through the limited functions of codecs.

By using the script's data structures, the software developers obtain better control and visibility over the video and audio data and metadata, thus extending the image/audio/video processing functions they can perform on the data and improving their ability to debug their algorithms or software.

FIG. 8 is a block diagram 800 of an architecture for categorization used by some embodiments of the invention. FIG. 8 categorizes the operators into five classes corresponding to references 804, 805, 806, 807 and 808. In some embodiments, 803 is a mapping of all the programming languages supported and whether they are compiled or interpreted. The ad-hoc media operators in embodiment 1 set forth above (in FIG. 2, FIG. 3 and FIG. 4) are included in Class 1, as referenced by 804. These operators correspond to ad-hoc controls such as the frame-by-frame graphical training-video editor in 400 in FIG. 4. Class 2, referenced by 805, uses common object-oriented class and object mappings to directly reference the media-file information. Class 3, as referenced by 806, uses common programming-language operators to define the media-programming language. Class 4, as referenced by 807, contains the numerous members of the open-ended set of media operators commonly used in the image, video, and audio industry. Classes 2, 3, and 4 are enabled in the embodiment of FIG. 6 and FIG. 7. Class 5, as referenced by 808, classifies certain operators according to their abstracted properties within Mathematical Category Theory. Mathematical Category Theory systematically classifies and constructs advanced continuous operators and representations from a fundamental basis of asymptotic expansions of discrete groups, sets and algebraic theories. The mathematical fields of functional analysis and systems theory construct composite operators, according to their fields' principles. This abstraction, according to a systematical classification provided by these three fields of mathematics (functional analysis, systems theory, and Mathematical Category Theory) is necessary to ensure the set of operators are complete for most scientific and engineering fields.

FIG. 9, FIG. 10, FIG. 11 and FIG. 12 provide enablement of the third embodiment described below. The third embodiment describes a method of processing light, enabled using the class 5 principles, reference 808 of FIG. 8, to process twelve (12)-band CMOS sensor inputs. The method is a variant of the method employed by human vision. The human vision system consists of Retinas, the Lateral Geniculate Nucleus (LGN), and the Primary Visual Cortex (PVC). The human method of processing images exemplifies the class 5 principles, referenced in 808, by using a sophisticated homomorphic transform to handle the complexity of information that arises when an object reflects light. In both the human and embodiment sensing, physical objects transform incident visual light according to the dichromatic reflection model or standard reflectance model—a transfer function differing for metals, homogeneous dielectrics and inhomogeneous dielectrics with colorants. They both perceive both the illumination light's Spectral Power Distribution (SPD) and the reflected light's SPD. Each non-metal physical object has a unique transfer function with the output creating a unique signature on a 2-D color-space plane. According to the validated dichromatic reflection model, a sensed red plastic cup is distinguishable from the same shaped red-metal cup, because the sub-surface scattering through metallic conductors and an inhomogeneous-plastic dielectric are different. But, the human visual system didn't evolve methods to identify objects this way. Instead, it evolved a method to control the explosion of information produced by variations in the reflectance SPD. It achieves this through antagonistic subtractions or additions of surrounding colors via center-surround filters. They reduce the color variations in an image to a smaller subset of constant colors. The LGN color constancy filtering is a homomorphic transform, referenced in 808, that reduces these small variations to a constant color. E.g., the human visual system reduces the color variations in green grass to a more symmetrical green, to reduce the amount of information it must process. This is a symmetry reduction with preserved structure, in a Linear Vector Space, but mapped to a 808 group homomorphic representation. The human vision system uses very fundamental group, algebraic, and separability methods from class 5, to reduce the complexity of information to a more symmetrical set whose properties are preserved in this transformation. Embodiment 3 is a variation on this method.

The human vision's homomorphic transform is useful for information reduction, but not for classifying objects by their material types. This embodiment reduces information by isolating the multiplied illumination and reflectance components in sensed light, I(λ)*R((λ), to both reduce information and to identify materials, using the Class 5, reference 808 of FIG. 8, methods and principles. The apparatus includes a Foveon CMOS sensor that samples and bandpass filters (splits) the visible light spectrum into twelve frequency bands. The sensor output is a color space consisting of the magnitudes of the outputs of the twelve frequency bands, instead of the traditional red, green, and blue SPDs (spectral power distributions).

FIG. 9A is a schematic cross-section diagram 900 showing a single pixel element in a Foveon×12 CMOS image sensor and the color-space pixel formed from twelve visible frequency bands. In FIG. 9A, reference 910 shows the Foveon-bandpass filtering of the reflected light into twelve bands, for a single pixel. Both the illuminated light 917, and the reflected light 918, penetrate the CMOS at depths 930, depending on the frequency. The shortest frequency, blue visible light, (this should not be confused with the blue SPD perceived by the human visual system) penetrates the CMOS at the shallowest depth, referenced by 928, while the red light frequency penetrates the CMOS at the deepest depth, referenced by 926. The light's photons create photoelectric electron-hole pairs in the p-n junction depletion regions referenced by 928, 921, and 922, thus creating a photodiode voltage or current source. The same effects occur at the other CMOS structures, which place each depletion region at a slightly deeper depth. The net result is collection of a magnitude for each of the 12 band-pass wavelength bands that span the visible light spectrum, as shown in reference 950 of FIG. 9B.

FIG. 9B is a graph 950 of the color-space pixel response (arbitrary units on the Y axis) versus frequency (wherein frequency bands b1 through r4 on the X axis map to light wavelengths of 400-700 nm). In some embodiments, the pixels can be stored as any RGB values in any color-space format, but because of the following processing, they should not be transformed to a neuro-physiological color space. The RGB values in neighboring spatial locations represent red, green, and blue magnitudes, but because they measure at slightly different frequencies, they are different. Yet, the pixel density remains unchanged.

FIG. 10 is a graph 1000 showing the reflectance spectral function for a green leaf and a green polycarbonate. The spectral responses (showing arbitrary Y units, and X units 1-12 (the frequency bands corresponding to twelve sensor bands of the CMOS sensor) corresponding to light wavelengths from 400 to 700 nm) from a green leaf 1001 and a green-polycarbonate plastic 1002 as shown. These unique standard-reflectance model's inhomogeneous dielectric signatures (except in the case of conductors) allows segmenting of objects, based on an invariant property. This symmetry reduction replaces the symmetry reduction achieved by color constancy in the human-visual system. The present embodiment uses a match filter from a library of pre-identified objects, but in other embodiments, other methods of identifying the signatures are possible.

FIG. 11 is a listing 1100 of media instructions included in one embodiment of an ISO media file containing 12 visible frequency bands. The media instructions to enable the match filer described for FIG. 10 for some embodiments are shown in FIG. 11. NXTCustom reads to frame 540, in reference 1101. It is a custom codec for handling the special 12-band pixels, mentioned previously. At the end of the arrow 405, is a polycarbonate light-green tray. The plurality of media instructions reads the 12-band pixel, at this location, in reference 1103, normalizes the array, and then multiplies it by the match-filter array for the light-green polycarbonate tray shown in 1002. Reference 1006 shows the match filter for the green-polycarbonate spectral signature. It is obtained by time reversing the signature's time series and multiplying every other element by −1, and then normalizing to 1. In reference 1104, if the match is 90% confident, then the Media Instructions writes a “green polycarbonate” text message to the display 1105.

FIG. 12 is a screen shot diagram 1200 showing a superposition of the frame used in FIG. 4, with the generated text box 1299 that says “Green polycarbonate” obtained using one method of capturing and annotating materials' properties on an Android mobile phone. The light-green polycarbonate tray in the background, is shown at reference 1205. In some embodiments, to display the FIG. 4 frames with media instructions in FIG. 11, the method of the present invention performs a conversion from the 12-band pixel-color space, to a CIE color space. This is easily done, but not necessary for some other embodiments.

The media instructions in this simple embodiment derived an object's transfer function that transforms an illumination SPD into a reflection SPD. In some embodiments, this allows the separation of the sensed light, I(λ)*R(λ), into its I and R components, where I and R are the illumination and reflection functions at the wavelength λ. With this separation, the information content of the light is reduced to a reflection function that is invariant to geometry and is constant across the object segment and an illumination function. In some embodiments, the media instructions compress the information content of the object by replacing pixels within this segment with its reflectance function, and a separated illumination function whose large dynamic range across the segmented region can be reduced. The example embodiment's purpose was not primarily to show this compression, but to show the enablement of the class 5, reference 808, operators in modeling and controlling an engineering or scientific field's phenomena, from sensor data that is read external to the media file. As used herein, the term “media-file” conforms to the ISO standard definition extended to include the present invention's augmented individual computer instructions, as well as scripts that include a plurality of instructions performed as a whole.

As used herein, the terms “box,” “container,” “hint track,” “media data box,” “track,” and “meta data” conform to the ISO standard definitions.

In some embodiments, the data architecture includes media instructions such as shown in Table 1.

TABLE 1

FREEINST: Instruction: Begin
STFR: Instruction: stop at frame
021C: frame number 540
ARGR: Instruction: Draw red arrow
00C8: Pixel coordinate 072
012C: Pixel coordinate 333
01E0: Pixel coordinate 278
01F4: Pixel coordinate 367
TXTB: Instruction: add text box
00CD: Pixel coordinate 390
012C: Pixel coordinate 052
ADD : ADD ¼ tsp salt
¼ :
tsp :
salt:
TXTE: Instruction: end text box
STBT: Instruction: start on button
BT01: button symbolic
INED: Instruction: end script

In some embodiments, the data architecture includes media instructions such as shown in Table 2.

TABLE 2

| ftyp box − file header info | |
|---|---|
| box size + “ftyp” box id + .. | |
| free box | |
| box size + “free” box id | |
| mdat box − video and audio frames | |
| box size + “mdat” box id + .. | |
| moov box − video and audio metadata | |
| box size + “moov” box id + .. | |
| free box − biometric and xfer script | |
| box size + “free” box id + | |
| INST | // identifies free box as instruction |

| | |
|---|---|
| VER 0000; | // identify the language version |

bestFrame = 0xffff;
for (i=0; i<32; i++)
{

| | |
|---|---|
| RAN r; | // gen time-sampled random # 0-0xffff |

LPrivateKey = r;

}
LprivateKey[0] &= 248;
LprivateKey[31] &= 127;
LprivateKey[31]|= 64;
LpublicKey = Curve25519(LprivateKey, base);
aesKey = CURVE2559(LprivateKey, RPublicKey);
while (nextF != 0)
{

nextF = GetFAddr(moov.stco_v);
if (nextF != NULL)
{

| x = NXTFrame(nextF) | // next FRAME |
|---|---|
| y = GAUSPYR(.75, 3, 2); // 3^{rd} level gauss pyramid | |
| y = WAVELET(x,WSQ,0.9); // Wavelet FBI WSQ basis | |
| y = WAVECROP(y); | // crop sparse boundaries |

| | |
|---|---|
| z = IWAVELET(y,WSQ); | // inverse wavelet |

| | |
|---|---|
| i = nextF/16; | // get # 16-byte blocks |

if (nextF.idr = FRAME) // if frame is i-frame
{

AES(aesKey, z, i); // encrypt pixels
INSERT(z, nextF); // reinsert, autoscale

| } | |
|---|---|
| j = ENTROPY(y); // measure symmetry | |
| if (j<bestE) | // if better info content |

{

| | |
|---|---|
| b = y; | // save best wavelet |

AES(aesKey, b, i); // encrypt pixels

| } | |
|---|---|
| y = UNITARY(x, KLT); | // KLT unitary transform |

}

| } | |
|---|---|
| financialdata = INTENT(<user financial url gui>); | |
| AES(aesKey,financialdata,4); | // encrypt 4*16 bytes |

| | |
|---|---|
| RAN x; | // randomize the data |
| RAN y; | // to obscure coming file |
| RAN z; | // write |

| SEND(<transaction URL>, receipt); // send file to rcvr | |
|---|---|
| REWRITE( ); | // rewrite this box to the file device |

| // callback invoked when receiving ack from receiver | |
|---|---|
| CALLBACK receipt | |
| { | |
| noop | |
| } | |
| INDA | // indentifies start of variable section |

| { | |
|---|---|
| BARRAY RPublicKey[32] = <remote site's public key>; | |
| BARRAY aesKey; | |
| BARRAY LPublicKey[32], LPrivateKey[32]; // local keys | |
| FRAME x[moov.stbl.stsd.width,moov.stbl.stsd.height]; | |
| BARRAY y[moov.stbl.stsd.width.moov.stbl.stsd.height]; | |
| BARRAY z[moov.stbl.stsd.width.moov.stbl.stsd.height]; | |
| BARRAY b[moov.stbl.stsd.width.moov.stbl.stsd.height]; | |
| INT j; | // entropy measure of wavelet data |

| | |
|---|---|
| INT w, h; | // width and height of sample image |

| INT bestFrame, i; | |
|---|---|
| ADDR nextF = 0xFFFF; | |
| BARRAY base[32] = {9}; | |
| BARRAY financialdata[64]; | |
| } | |
| INED | // uniquely identifies free box as instruction |

In some embodiments, the data architecture includes media instructions such as shown in Table 3.

TABLE 3
ftyp box (file header info): {box size + “ftyp” box id + .. }
free box: {box size + “free” box id}
mdat box (media data): {box size + “mdat” box id + ..}
moov box (movie meta data): {box size + “moov” box id + ..}
free box (biometric and transfer script embodiment): {box size + “free”
box id +

| | |
|---|---|
| INST | // identifies free box as instruction |

| | |
|---|---|
| VER 0000; | // identify the language version |

| | |
|---|---|
| while (nextF != 0) | // process all frames |

{

| nextF = GetFAddr(moov.stco_v); // get frame's addr (offset from file | |
|---|---|
| start) | |
| if (nextF != NULL) | |
| { | |
| x = NXTFCustom(nextF) | // Use custom codec to decode |
| frame | |
| if (j == 540) { | // if frame 540 |

// get maximum spectral value from 12-band pixel
for (k=0; k<12; k++) {

if (max< x[278, 1101+k]) max = x[278, 1101+k]; }

for (k=0; k<12; k++) { // match filter with white

polycarbonate match = match + (x[278,
1101+k]/max * MatchFilter[k]);}

```
  }
  if (match/n2 < 0.1) { // if 90% confident of green polycarb
```

match TXTB(390,52, “green polycarbonate”); TXTE( );}

j = j+1;
}

}

| | |
|---|---|
| INDA | // indentifies start of variable section |

{
FRAME x[moov.stbl.stsd.width,moov.stbl.stsd.height];

| | |
|---|---|
| INT j = {0}; | // frame number being processing |

| | |
|---|---|
| BARRAY PIXEL[12]]; | // 12-band color space pixel |

RARRAY MatchFilter[12] = {0.811429 , −0.51429 , 0.297143 ,

−0.24, 0.285714 , −0.51429, 1.0 , −1.42857,
0.714286, −0.25714, 0.171429, −0.13714} // green
polycarb

| | |
|---|---|
| REAL n2; = {5.08}; | // Match Filter max match |

```
  INT max = {0};
  REAL w = {0};
  REAL match = {0};
```

}

| | |
|---|---|
| INED | // uniquely identifies free box as instruction |

In some embodiments, the architecture includes media instructions to annotate one or more frames in a range of frame with text or graphics.

In some embodiments, the architecture includes image-processing and audio-processing media instructions to modify the image, video and audio frames.

In some embodiments, the architecture includes image-processing and audio-processing media instructions to compress image, video and audio frames.

In some embodiments, the architecture includes media instructions to unitary video, image or audio frames.

In some embodiments, the architecture includes media instructions to control a range of frames, possibly separate from other range of frames.

In some embodiments, the architecture includes media instructions to control the invention's instructions or scripts.

In some embodiments, the architecture includes media instructions to insert video tracks, audio tracks, from external sources, into the existing tracks.

In some embodiments, the architecture includes media instructions to insert special effects into the existing video or audio tracks.

In some embodiments, the architecture includes media instructions that provide conditional control of the invention's instructions or scripts.

In some embodiments, the architecture includes media instructions to dynamically pan in and out of an area of interest, or scale the video to a different size.

In some embodiments, the architecture includes media instructions to receive data from a plurality of hardware elements external to the media file.

In some embodiments, the architecture includes media instructions to transmit data to a plurality of hardware elements external to the media file.

In some embodiments, the architecture includes media instructions to effect Java-Style Intents.

In some embodiments, the present invention provides a data structure in an ISO media file. The media file is stored on a computer-readable medium, and the data structure includes: a plurality of media instructions stored within instruction-suitable fields of the ISO media file wherein the media instructions apply functional transforms based on input information to modify media data output and to send control and data to a computer device.

In some embodiments of the data structure, the input information is elicited and received from a user upon the media file being played.

In some embodiments of the data structure, the input information is obtained from an ISO media box data structure.

In some embodiments of the data structure, the plurality of media instructions includes instructions that annotate at least one frame in a predetermined range of frames with text or graphics.

In some embodiments of the data structure, the plurality of media instructions includes image-processing and audio-processing instructions that cause a media-file player to filter and transform the image and audio frames and identify objects.

In some embodiments of the data structure, the image-processing and audio-processing media instructions implement operators to interpolate between video output frames.

In some embodiments of the data structure, the plurality of media instructions includes image-processing and audio-processing instructions implement operators to up sample video output.

In some embodiments of the data structure, the plurality of media instructions includes image-processing and audio-processing instructions that implement operators to down sample video output.

In some embodiments of the data structure, the plurality of media instructions include image-processing and audio-processing instructions that implement operators to transform output data from images normally provided into augmented output data having modified, alternative, or new images of video output.

In some embodiments of the data structure, the plurality of media instructions includes image-processing and audio-processing instructions that implement operators to transform audio data into audio output.

In some embodiments of the data structure, the plurality of media instructions includes mathematical operators that operate in a plurality of mathematical spaces that correspond to the respective mathematical operators.

In some embodiments of the data structure, the plurality of media instructions includes image-processing and audio-processing instructions that implement a plurality of different filters to filter images and audio.

In some embodiments of the data structure, the plurality of media instructions includes image-processing and audio-processing instructions that implement a plurality of filters that identify, edge, segment, and extract objects in image data.

In some embodiments of the data structure, the plurality of media instructions includes image-processing and audio-processing instructions to implement a plurality of filters that filter audio data.

In some embodiments of the data structure, the plurality of media instructions includes image-processing instructions to transform color spaces.

In some embodiments of the data structure, the plurality of media instructions code and decode (via codec operations) the ISO media and meta data.

In some embodiments of the data structure, the plurality of media instructions encrypt data going into the media file and decrypt data coming from the media file.

In some embodiments of the data structure, the plurality of media instructions includes temporal inter-frame motion compensation and estimations.

In some embodiments of the data structure, the plurality of media instructions includes image-processing and audio-processing instructions to derive statistical data from the images and audio.

In some embodiments of the data structure, the plurality of media instructions includes image-processing and audio-processing instructions to denoise video and audio.

In some embodiments of the data structure, the plurality of media instructions includes image-processing and audio-processing instructions to enhance video and audio.

In some embodiments of the data structure, the plurality of media instructions includes image-processing and audio-processing instructions to deblur video and audio.

In some embodiments of the data structure, the plurality of media instructions includes image-processing and audio-processing instructions to inpaint video.

In some embodiments of the data structure, the plurality of media instructions includes image-processing and audio-processing instructions to restore audio, video, and image data.

In some embodiments of the data structure, the plurality of media instructions includes operators that might indirectly compress audio and visual data, through transforms that alter a video, image, and audio data's dynamic range or color/spectral representation.

In some embodiments of the data structure, the plurality of media instructions perform methods to apply common unitary transforms to the video, image, and/or audio frames. In some embodiments, the unitary transforms include such common conventional operations as expanding an image into an orthogonal basis-image representation, transforming an image into a separable representation, reducing the correlation between transform coefficients, and rotating an image.

In some embodiments of the data structure, the plurality of media instructions perform methods to apply homomorphic transforms to the video, image, and/or audio frames. In some embodiments, the homomorphic transform reduces image information content into a lossy representation of pertinent information in the image such as its object reflection-function.

In some embodiments of the data structure, the plurality of media instructions perform methods to apply common singular-value-decomposition transforms to the video, image, and/or audio frames. In some embodiments, the transform expand an image into a common singular-value-decomposition representation to maximize energy compaction of the image-representation basis coefficients.

In some embodiments of the data structure, the plurality of media instructions perform methods to apply common dynamic-systems transforms to the video, image, and/or audio frames, to produce a media-instruction-modified output signal. In some embodiments, the dynamic system transforms uses state information in the image, to produce a media-instruction-modified output signal.

In some embodiments of the data structure, the plurality of media instructions performs methods to apply common statistical-transforms to the video, image, and/or audio frames. In some embodiments, a common statistical-transform constructs pixel histograms.

In some embodiments of the data structure, the plurality of media instructions performs methods to apply a plurality of operations selected from the set consisting of unitary, homomorphic, dynamic-systems, and statistical transforms to the video, image, and/or audio frames.

In some embodiments, the media file of the present invention is an ISO Media File.

In some embodiments of the data structure, the plurality of media instructions performs methods to receive data from a plurality of hardware elements external to the media file. In some embodiments, such instructions cause the computer to receive data from memory, display drivers, peripheral drivers, relays, actuators, peripheral buses, peripherals, processor pin-outs, processor control registers, address decoders, co-processors and floating-point processors, outputs to ASICs, FPGAs, flip-flops, and/or any other type of hardware inputs.

In some embodiments of the data structure, the plurality of instructions includes instructions that perform methods to transmit data to a plurality of hardware elements external to the media file. In some embodiments, such instructions transmit data to memory, peripheral drivers, sensors, peripheral buses, peripherals, processor pin-ins, processor control and status registers, co-processors and floating-point processors, ASICs inputs, FPGA inputs, and/or any other type of hardware output.

In some embodiments of the data structure, the operators rotate an image.

In some embodiments of the data structure, the operators transform the image to preserve the information content of the image.

In some embodiments of the data structure, the operators preserve only specific structures in the image or audio data.

In some embodiments of the data structure, the operators form separable mappings into the image space.

In some embodiments of the data structure, the operators derive statistical information.

In some embodiments of the data structure, the operators provide dynamic control.

In some embodiments of the data structure, the ISO media file is an ISO base media file.

In some embodiments, the present invention provides a data structure in a box within an ISO media file, wherein the ISO media file is stored on a non-transitory computer-readable medium. The data structure includes a plurality of media instructions stored within instruction-suitable fields of the box within the ISO base media file, wherein the media instructions, when executed, functionally transform video information from the media file, based on data in the data structure, to a media-instruction-modified output signal that includes video modified by the input information and the data in the data structure.

In some embodiments, the present invention provides a data structure in a box within an ISO media file, wherein the ISO media file is stored on a non-transitory computer-readable medium. The data structure includes a plurality of media instructions stored within instruction-suitable fields of the box within the ISO base media file, wherein the media instructions, when executed, functionally transform video information from the media file, based on input information elicited and received from a human user and on data in the data structure, to a media-instruction-modified output signal that includes video modified by the input information and the data in the data structure.

In some embodiments, a data structure of the present invention further includes computer programming-language type declarations that implement a plurality of computer programming language types.

In some embodiments, a data structure of the present invention further includes computer-programming type definitions that map to media file boxes and data structures within boxes.

In some embodiments, the plurality of media instructions in a data structure of the present invention include computer programming-language data-structure declarations that allocate and define data-structure storage within storage-suitable fields of the ISO media file and its memory buffers.

In some embodiments, the plurality of media instructions in a data structure of the present invention include computer programming-language instructions that implement a computer-programming language.

In some embodiments, the input information includes data read from computer-system runtime-services and the media-instruction-modified output signal includes data written to computer system runtime-services.

In some embodiments, the input information includes data read from input signals (see definition in terms section) and the output comprise data written to output signals.

In some embodiments, the input information includes data read from media-file boxes and the media-instruction-modified output signal includes data written to media-file boxes.

In some embodiments, the plurality of media instructions in a data structure of the present invention control playback of a range of media-file video and audio frames, as determined from input information elicited and received from the human user, to an output device, such that a subset of the range of frames are cut from the playback.

In some embodiments, the plurality of media instructions in a data structure of the present invention control playback of a range of media-file video and audio frames, as determined from input information elicited and received from the human user, to an output device, such that video playback is stopped at a particular frame in the range, based on the media instructions.

In some embodiments, the plurality of media instructions in a data structure of the present invention annotate at least one frame in a predetermined range of frames with text.

In some embodiments, the plurality of media instructions in a data structure of the present invention annotate at least one frame in a predetermined range of frames with graphics.

In some embodiments, the plurality of media instructions in a data structure of the present invention mathematically transform image, video, and audio frames and identify objects.

In some embodiments, the plurality of media instructions in a data structure of the present invention include conditionally executed instructions.

In some embodiments, the plurality of media instructions in a data structure of the present invention insert video tracks and audio tracks into existing tracks of the media file.

In some embodiments, the plurality of media instructions in a data structure of the present invention cause video output to dynamically pan in and out of an area of interest.

In some embodiments, the plurality of media instructions in a data structure of the present invention cause video output to dynamically scale the video to different sizes.

In some embodiments, the plurality of media instructions in a data structure of the present invention effect Java-Style Intents.

In some embodiments, the present invention provides a computer-implemented method that includes reading a media file into an information processor from a non-transitory computer-readable medium, wherein the media file includes media-file data, input information, and a playback-control data structure that includes a plurality of media instructions stored within instruction-suitable fields of the media file; eliciting and receiving input information from a human user; and functionally transforming the media file data based on the input information received from the human user into an output signal as controlled by the plurality of media instructions.

In some embodiments, the present invention provides a computer-implemented method that includes reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and storing the transformed media file data back to the non-transitory computer-readable medium.

In some embodiments, the present invention provides a computer-implemented method that includes reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and outputting the transformed media file data to a video-output device.

In some embodiments, the method further includes implementing a plurality of computer programming language types using computer programming-language type declarations from a box in the media file, based on the media file instructions.

In some embodiments, the method further includes mapping to media file boxes and data structures within boxes using computer-programming type definitions in a box of the media file using computer-programming type definitions from a box in the media file, based on the plurality of media file instructions.

In some embodiments, the method further includes allocating and defining data-structure storage within storage-suitable fields of the ISO media file and its memory buffers using computer programming-language data-structure declarations in a box of the media file, based on the plurality of media file instructions.

In some embodiments, the method further includes annotating at least one frame in a predetermined range of frames with graphics.

In some embodiments, the method further includes inserting video tracks and audio tracks into existing tracks of the media file.

In some embodiments, the present invention provides a non-transitory computer-readable medium storing computer-executable instructions that, when executed on one or more processors, perform a method using the architecture and media instructions as set forth herein.

In some embodiments, the present invention provides a non-transitory computer-readable medium having computer-executable instructions stored thereon, which, when executed on suitable computer system, perform a method that includes reading a media file into an information processor from a non-transitory computer-readable medium, wherein the media file includes media-file data, input information, and a playback-control data structure that includes a plurality of media instructions stored within instruction-suitable fields of the media file; eliciting and receiving input information from a human user; and functionally transforming the media file data based on the input information received from the human user into an output signal as controlled by the plurality of media instructions.

In some embodiments, the present invention provides a non-transitory computer-readable medium having computer-executable instructions stored thereon, which, when executed on suitable computer system, perform a method that includes reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and storing the transformed media file data back to the non-transitory computer-readable medium.

In some embodiments, the present invention provides a non-transitory computer-readable medium having computer-executable instructions stored thereon, which, when executed on suitable computer system, perform a method that includes reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and outputting the transformed media file data to an audio and/or video output device.

In some embodiments, the present invention provides a non-transitory computer-readable medium having stored thereon an ISO media file, wherein the ISO media file includes a data structure that includes a plurality of media instructions stored within instruction-suitable fields of the box within the ISO base media file, wherein the plurality of media instructions, when executed, functionally transform video information from the media file, based on input information elicited and received from a human user and on data in the data structure, to a media-instruction-modified output signal that includes video modified by the input information and the data in the data structure.

In some embodiments, the present invention provides a computer that includes means for reading a media file into an information processor from a non-transitory computer-readable medium, wherein the media file includes media-file data, input information, and a playback-control data structure that includes a plurality of media instructions stored within instruction-suitable fields of the media file; means for eliciting and receiving input information from a human user; and means for functionally transforming the media file data based on the input information received from the human user into a media-instruction-modified output signal as controlled by the plurality of media instructions.

In some embodiments, the present invention provides a computer that includes means for reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and storing the transformed media file data back to the non-transitory computer-readable medium.

In some embodiments, the present invention provides a computer that includes means for reading a media file into an information processor from a non-transitory computer-readable medium, wherein the media file includes media-file data, input information, and a playback-control data structure that includes a plurality of media instructions stored within instruction-suitable fields of the media file; and functionally transforming the media file data based on the plurality of media instructions and outputting the transformed media file data to a video-output device.

In some embodiments, the present invention provides a computer that includes a media-file input unit that reads a media file into an information processor from a computer-readable medium, wherein the media file includes media-file data, input information, and a playback-control data structure that includes a plurality of media instructions stored within instruction-suitable fields of the media file, wherein the plurality of media instructions include a plurality of instructions, an input unit configured to elicit and receive input information from a human user; and a functional-transformation unit that transforms the media file data based on the input information received from the user into a media-instruction-modified output signal as controlled by the plurality of media instructions.

In some embodiments, the present invention provides a computer that includes a media-file input unit that reads a media file into an information processor from a computer-readable medium, wherein the media file includes media-file data, input information, and a playback-control data structure that includes a plurality of media instructions stored within instruction-suitable fields of the media file, wherein the plurality of media instructions include a plurality of instructions, an input unit configured to receive input information; and a functional-transformation unit that transforms the media file data based on the input information into transformed media file data, as controlled by the plurality of media instructions.

In some embodiments, the present invention provides a computer that includes a media-file input unit that reads a media file into an information processor from a computer-readable medium, wherein the media file includes media-file data, input information, and a playback-control data structure that includes a plurality of media instructions stored within instruction-suitable fields of the media file, wherein the media instructions include a plurality of instructions, an input unit configured to receive input information; and a functional-transformation unit that transforms the media file data based on the input information into an output signal as controlled by the media instructions. In some embodiments, the output signal is transmitted to a video output device. In other embodiments, the output signal is written back into the media file on the computer-readable medium. In other embodiments, the output signal is written back into another media file.

Some embodiments further include a mapper that maps to media file boxes and data structures within boxes using computer-programming type definitions in a box of the media file using computer-programming type definitions from a box in the media file, based on the plurality of media file instructions.

Some embodiments further include an allocation and definition unit that allocates and defines data-structure storage within storage-suitable fields of the ISO media file and its memory buffers using computer programming-language data-structure declarations in a box of the media file, based on the plurality of media file instructions.

Some embodiments further include an annotation unit that annotates at least one frame in a predetermined range of frames with graphics, based on the plurality of media file instructions.

Some embodiments further include an insertion unit that inserts video tracks and audio tracks into existing tracks of the media file, based on the plurality of media file instructions.

In some embodiments, the ISO media file is stored on re-writable memory devices such as SDHC (secure-data high capacity) cards, hard-disk drives, optical disk drives, FLASH drives, SSDs (solid-state drives) and/or the like. In some embodiments, the ISO media file is stored on read-only memory devices such as ROM (read-only) cards, optical disks, FLASH drives and/or the like. In some embodiments, any description herein that refers to the “plurality of media file instructions” includes the case wherein a single media file instruction (perhaps having a plurality of parameters) stored in a box in an ISO media file performs the recited functions that are effected by the plurality of media file instructions.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A data structure in a box within an ISO media file, wherein the ISO media file is stored on a non-transitory computer-readable medium, the data structure comprising:
a plurality of media instructions stored within instruction-suitable fields of the box within the ISO base media file, wherein the plurality of media instructions, when executed, functionally transform video information from the media file, based on data in the data structure, to a media-instruction-modified output signal that includes video modified by the input information and the data in the data structure.

2. The data structure of claim 1, further comprising computer programming-language type declarations that implement a plurality of computer programming language types.

3. The data structure of claim 1, further comprising computer-programming type definitions that map to media file boxes and data structures within boxes.

4. The data structure of claim 1, wherein the plurality of media instructions comprise computer programming-language data-structure declarations that allocate and define data-structure storage within storage-suitable fields of the ISO media file and its memory buffers.

5. The data structure recited in claim 1, wherein the plurality of media instructions control playback of a range of media-file video and audio frames, as determined from input information elicited and received from the human user, to an output device, such that a subset of the range of frames are cut from the playback.

6. The data structure recited in claim 1, wherein the plurality of media instructions control playback of a range of media-file video and audio frames, as determined from input information elicited and received from the human user, to an output device, such that video playback is stopped at a particular frame in the range, based on the media instructions.

7. The data structure of claim 1, wherein the plurality of media instructions annotate at least one frame in a predetermined range of frames with graphics.

8. The data structure recited in claim 1, wherein the plurality of media instructions insert video tracks and audio tracks into existing tracks of the media file.

9. The data structure recited in claim 1, wherein the plurality of media instructions dynamically scale the video to different sizes.

10. A computer-implemented method comprising:
reading a media file into an information processor from a non-transitory computer-readable medium, wherein the media file includes media-file data, input information, and a playback-control data structure that includes a plurality of media instructions stored within instruction-suitable fields of the media file; and
functionally transforming the media-file data based on the media instructions and outputting the transformed media-file data as a media-instruction-modified output signal.

11. The computer-implemented method of claim 10, further comprising implementing a plurality of computer programming language types using computer programming-language type declarations from a box in the media file, based on the plurality of media file instructions.

12. The computer-implemented method of claim 10, further comprising mapping to media file boxes and data structures within boxes using computer-programming type definitions in a box of the media file using computer-programming type definitions from a box in the media file, based on the plurality of media file instructions.

13. The computer-implemented method of claim 10, further comprising allocating and defining data-structure storage within storage-suitable fields of the ISO media file and its memory buffers using computer programming-language data-structure declarations in a box of the media file, based on the plurality of media file instructions.

14. The computer-implemented method of claim 10, further comprising annotating at least one frame in a predetermined range of frames with graphics.

15. The computer-implemented method of claim 10, further comprising inserting video tracks and audio tracks into existing tracks of the media file.

16. A computer comprising:
a media-file input unit that reads a media file into an information processor from a computer-readable medium, wherein the media file includes media-file data, input information, and a playback-control data structure that includes a plurality of media instructions stored within instruction-suitable fields of the media file, wherein the plurality of media instructions include a plurality of instructions,
an input unit configured to elicit and receive input information from a human user; and
a functional-transformation unit that transforms the media-file data based on the input information received from the human user into a media-instruction-modified output signal as controlled by the media instructions.

17. The computer of claim 16, further comprising a mapper that maps to media file boxes and data structures within boxes using computer-programming type definitions in a box of the media file using computer-programming type definitions from a box in the media file, based on the plurality of media file instructions.

18. The computer of claim 16, further comprising an allocation and definition unit that allocates and defines data-structure storage within storage-suitable fields of the ISO media file and its memory buffers using computer programming-language data-structure declarations in a box of the media file, based on the plurality of media file instructions.

19. The computer of claim 16, further comprising an annotation unit that annotates at least one frame in a predetermined range of frames with graphics, based on the plurality of media file instructions.

20. The computer of claim 16, further comprising an insertion unit that inserts video tracks and audio tracks into existing tracks of the media file, based on the plurality of media file instructions.
